(19) United States
(12) Patent Application Publication
(10) Pub. No.: US 2026/0269292 A1
(43) Pub. Date: Sep. 10, 2026

(54) INTEGRATED ELECTROCHEMICAL ENERGY AND WATER GENERATION SYSTEM WITH CLOSED-LOOP CARBON CONVERSION

(71) Applicant: Civis Tech Global, Corp., Conroe, TX (US)

(72) Inventor: Julie C. Andrews, Conroe, TX (US)

(21) Appl. No.: 19/541,868

(22) Filed: Feb. 17, 2026

Related U.S. Application Data
(60) Provisional application No. 63/759,080, filed on Feb. 15, 2025.

(51) Int. Cl. H01M 8/06; H01M 8/04082; H01M 8/04302; H01M 8/04828; H01M 8/04858

(52) U.S. Cl. CPC H01M 8/06; H01M 8/04201; H01M 8/04302; H01M 8/04828; H01M 8/04947

(57) ABSTRACT

An integrated electrochemical system couples an electrochemical carbon dioxide reduction reactor with an electrochemical fuel cell subsystem in a closed-loop configuration. The reactor electrochemically converts carbon dioxide and an aqueous electrolyte into a reduced carbon liquid fuel stored in a shared fuel storage tank. The fuel cell subsystem electrochemically converts the reduced carbon liquid fuel into electrical energy and water. Carbon-containing species from the fuel cell subsystem are returned to a shared electrolyte storage tank for reuse by the reactor, enabling internal carbon recirculation without carbon discharge. Following a startup phase, the fuel cell subsystem generates sufficient electrical energy to power the reactor and internal components while providing net surplus electrical energy for external use. A water recovery subsystem recovers water as a useful output. A supervisory control system enables selection among operating modes prioritizing energy production, water production, or energy storage. The system supports modular scalable deployment.

### CROSS-REFERENCE TO RELATED APPLICATIONS

The present application claims priority to U.S. Provisional Application No. 63/759,080 filed Feb. 15, 2025, titled “INTEGRATED ELECTROCHEMICAL ENERGY AND WATER GENERATION SYSTEM WITH CLOSED-LOOP CABRON CONVERSION,” which is hereby incorporated by reference.

### TECHNICAL FIELD

The embodiments generally relate to the technical field of electrochemical energy conversion systems. More particularly, the present invention relates to an integrated electrochemical system configured for closed-loop carbon dioxide reduction and fuel cell-based energy generation with coordinated recovery of electrical energy and water.

### BACKGROUND

Electrochemical carbon dioxide reduction systems convert carbon dioxide into reduced carbon products such as formate or other chemical intermediates. These systems generally function as standalone reactors that consume external electrical power to drive the reduction process. The reduced carbon products are typically collected as end products for chemical use or storage rather than utilized within the same system for downstream energy recovery. As a result, electrochemical carbon dioxide reduction systems operate as net energy consumers and do not recover energy from the products they generate.

Fuel cell systems convert chemical fuels into electrical energy through electrochemical oxidation and produce water as a reaction byproduct. Conventional fuel cell systems rely on a continuous supply of externally sourced fuel and treat carbon dioxide generated during fuel oxidation as a waste stream that is vented or otherwise discarded. Water produced during fuel cell operation is generally managed for humidity control or thermal regulation rather than captured as a recoverable product output. These systems do not regenerate consumed fuel internally and require uninterrupted access to external fuel supplies to sustain operation.

Existing approaches that combine carbon capture, electrolysis, and power generation typically connect these functional elements as separate units through external infrastructure and independent control systems. Modular or containerized energy systems scale power generation or storage capacity by duplicating complete independent units, each with dedicated storage and support hardware. These configurations do not share common fluid reservoirs across multiple electrochemical subsystems and do not coordinate the simultaneous production of electrical energy and water as dual useful outputs from a single operating architecture.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

The present invention provides an integrated electrochemical system that couples an electrochemical carbon dioxide reduction reactor with an electrochemical fuel cell subsystem in a closed-loop configuration. The electrochemical carbon dioxide reduction reactor receives carbon dioxide and an aqueous electrolyte and electrochemically converts the carbon dioxide into a reduced carbon liquid fuel. The electrochemical fuel cell subsystem receives the reduced carbon liquid fuel and electrochemically converts it into electrical energy, generating water as a byproduct. A return pathway returns carbon-containing species from the electrochemical fuel cell subsystem to a shared electrolyte storage tank, enabling internal recirculation of carbon-containing species without carbon discharge during normal operation. Following an initial startup phase, the electrical energy generated by the electrochemical fuel cell subsystem is sufficient to power the electrochemical carbon dioxide reduction reactor and internal system components while providing net surplus electrical energy for external use.

The system includes a shared electrolyte storage tank and a shared fuel storage tank fluidly connected to the electrochemical carbon dioxide reduction reactor and the electrochemical fuel cell subsystem through a fluid circulation system comprising conduits, manifolds, and valves. This shared storage architecture enables the reduced carbon liquid fuel consumed during energy generation to be regenerated through electrochemical reduction of the internally recirculated carbon-containing species, thereby sustaining operation from a fixed carbon inventory without continuous external fuel supply. A water recovery subsystem collects water generated during electrochemical energy production and recovers it as a useful output of the system.

The system supports a plurality of operating modes using a common physical architecture. The operating modes include an energy production mode that prioritizes net electrical energy production, a water production mode that prioritizes recovery of water as a useful output, and an energy storage mode in which reduced carbon liquid fuel is generated and stored for later energy production. A supervisory control system comprising sensors and control logic coordinates operation of the electrochemical subsystems, fluid circulation, and energy flows, and in certain embodiments employs adaptive algorithms or artificial intelligence-based methods to optimize efficiency and dynamically select among operating modes.

The present invention further provides a modular electrochemical system in which a plurality of electrochemical modules are housed within an enclosure and share the common electrolyte and fuel storage tanks. Each electrochemical module comprises an electrochemical carbon dioxide reduction reactor and an electrochemical fuel cell subsystem connected to the shared storage infrastructure. The modular architecture permits scalable deployment by addition or removal of electrochemical modules while maintaining the shared storage tanks and core system infrastructure. In certain embodiments, the enclosure comprises a transportable containerized structure. The electrochemical carbon dioxide reduction reactors and the electrochemical fuel cell subsystems may comprise non-precious and non-rare catalyst materials.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 is a system-level block diagram of an integrated electrochemical system illustrating the electrochemical carbon dioxide reduction reactor, the electrochemical fuel cell subsystem, the shared electrolyte storage tank, the shared fuel storage tank, the return pathway, the water recovery subsystem, the supervisory control system, the enclosure, an external power source for initial startup, and an external electrical load receiving surplus electrical energy;

FIG. 2 is a cross-sectional view of the electrochemical carbon dioxide reduction reactor illustrating the anode, the cathode, the separator or membrane, the DC power source, the anolyte inlet, the anolyte and gas outlet, and the reduced carbon liquid fuel stream outlet;

FIG. 3 is a detailed system schematic of a single-module embodiment of the integrated electrochemical system illustrating the electrochemical carbon dioxide reduction reactor, the electrochemical fuel cell subsystem, the shared electrolyte storage tank, the shared reduced-carbon fuel storage tank, the water recovery subsystem, the supervisory control system, pumps, valves, fluid conduits, and connections for recovered water output and external electrical surplus output or initial startup power, all housed within an enclosure;

FIG. 4 is a detailed schematic of the water recovery subsystem illustrating the inlet from the fuel cell subsystem, the condenser, the gas-liquid separator vessel, the gas outlet, the water storage vessel, a water quality sensor, a flow sensor communicating with the supervisory control system, and the recovered water outlet; and

FIG. 5 is a system-level block diagram of a modular electrochemical system illustrating a plurality of electrochemical modules each comprising an electrochemical carbon dioxide reduction reactor and an electrochemical fuel cell subsystem, the shared electrolyte storage tank, the shared fuel storage tank, the water recovery subsystem, the supervisory control system, pumps, power distribution and balance-of-plant components, an external energy source, and an external load or grid connection.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The following description provides a thorough explanation of embodiments of an integrated electrochemical system configured for closed-loop carbon dioxide reduction, fuel cell-based energy generation, and water recovery. The description enables a person having ordinary skill in the art to make and use the embodiments described herein. Various modifications, alternatives, and equivalents will be apparent to those skilled in the art, and the scope of protection is defined by the claims appended hereto rather than by the specific embodiments described below.

An integrated electrochemical system comprises an electrochemical carbon dioxide reduction reactor, an electrochemical fuel cell subsystem, a shared electrolyte storage tank, a shared fuel storage tank, a fluid circulation system, a water recovery subsystem, and a supervisory control system. These components operate together in a closed-loop configuration in which carbon-containing species cycle between reduced and oxidized states within the system without carbon discharge during normal operation. The system may be housed within an enclosure, which may comprise a transportable containerized structure such as a shipping-container-sized unit, although other enclosure types, form factors, and installation configurations may be used.

The electrochemical carbon dioxide reduction reactor receives carbon dioxide and an aqueous electrolyte and electrochemically converts the carbon dioxide into a reduced carbon liquid fuel. The reactor comprises one or more electrochemical cells, each cell including an anode, a cathode, and a separator or membrane disposed between the anode and the cathode. The cathode receives the aqueous electrolyte containing dissolved carbon dioxide or dissolved carbon species such as bicarbonate or carbonate ions. When electrical energy is applied across the electrochemical cell, carbon dioxide is electrochemically reduced at the cathode surface to produce a reduced carbon liquid fuel. The reduced carbon liquid fuel may comprise formate, formic acid, or other reduced carbon species suitable for subsequent electrochemical oxidation. The anode may facilitate a complementary oxidation reaction, such as oxygen evolution from water, to complete the electrochemical circuit. The separator or membrane may comprise an ion-exchange membrane, a polymer electrolyte membrane, or other material configured to permit selective ionic transport between the anode and cathode while preventing mixing of anolyte and catholyte streams. The catalyst materials used at the cathode and anode may comprise non-precious and non-rare materials, including but not limited to non-precious metal catalysts, mixed metal catalysts, metal oxides, metal alloys, bio-derived catalysts, enzyme-based catalysts, or combinations thereof. Electrode structures may comprise porous metals, meshes, foams, fibers, coated substrates, or other conductive or semi-conductive materials suitable for electrochemical reactions. The reactor may operate at ambient or moderate temperatures using aqueous electrolytes, and the electrolyte composition may include buffered aqueous solutions, potassium bicarbonate solutions, or other aqueous media configured to dissolve and transport carbon species. Carbon dioxide supplied to the reactor may originate from the shared electrolyte storage tank through internal recirculation, from an external source during startup or supplemental operation, or from combinations thereof.

The electrochemical fuel cell subsystem receives the reduced carbon liquid fuel from the shared fuel storage tank and electrochemically converts the reduced carbon liquid fuel into electrical energy. The fuel cell subsystem comprises one or more electrochemical fuel cells, each fuel cell including an anode, a cathode, and a membrane or separator disposed between the anode and cathode. The reduced carbon liquid fuel, such as formate in aqueous solution, is delivered to the anode of the fuel cell, where it undergoes electrochemical oxidation. During oxidation, the reduced carbon liquid fuel releases electrons to an external circuit, generating electrical current, and produces carbon dioxide and protons or other ionic species as reaction products. Water is generated as a byproduct of the electrochemical conversion, typically at the cathode where oxygen is reduced and combines with protons transported through the membrane. The membrane or separator in the fuel cell subsystem may comprise a proton exchange membrane, an anion exchange membrane, or other ion-selective material appropriate for the selected fuel and electrolyte chemistry. The catalyst materials at the fuel cell anode and cathode may comprise non-precious and non-rare materials, consistent with those described for the electrochemical carbon dioxide reduction reactor. The fuel cell subsystem generates a liquid effluent stream from the anode side that contains electrolyte and dissolved or entrained carbon dioxide produced during fuel oxidation. This liquid effluent stream exits the fuel cell subsystem and enters the return pathway for delivery back to the shared electrolyte storage tank.

The shared electrolyte storage tank stores the aqueous electrolyte containing dissolved carbon species. The tank is fluidly connected to both the electrochemical carbon dioxide reduction reactor and the electrochemical fuel cell subsystem through the fluid circulation system. The shared electrolyte storage tank receives liquid effluent from the fuel cell subsystem through the return pathway, and the liquid effluent carries dissolved carbon dioxide or other carbon-containing species generated during fuel oxidation. These carbon-containing species are thereby made available in the aqueous electrolyte for delivery to the electrochemical carbon dioxide reduction reactor, where they undergo electrochemical reduction to regenerate the reduced carbon liquid fuel. The tank may comprise a sealed or vented vessel constructed from chemically compatible materials such as stainless steel, high-density polyethylene, or other corrosion-resistant materials suitable for containing the selected aqueous electrolyte. The tank may include level sensors, temperature sensors, and concentration sensors to monitor electrolyte volume, temperature, and carbon species concentration.

The shared fuel storage tank stores the reduced carbon liquid fuel generated by the electrochemical carbon dioxide reduction reactor. The tank is fluidly connected to the electrochemical carbon dioxide reduction reactor, which delivers freshly produced reduced carbon liquid fuel to the tank, and to the electrochemical fuel cell subsystem, which draws stored fuel from the tank for electrochemical conversion. The shared fuel storage tank may comprise a sealed vessel constructed from chemically compatible materials and may include sensors for monitoring fuel volume, concentration, and temperature. The capacity of the shared fuel storage tank may be selected based on the desired operating duration, the number of electrochemical modules connected to the tank, and the intended balance between energy production and energy storage operating modes.

The fluid circulation system comprises conduits, manifolds, valves, and pumps connecting the shared electrolyte storage tank, the shared fuel storage tank, the electrochemical carbon dioxide reduction reactor, and the electrochemical fuel cell subsystem. The conduits may comprise tubing or piping constructed from chemically resistant materials such as fluoropolymers, stainless steel, or reinforced polymers. The manifolds distribute fluid flow from common supply lines to multiple electrochemical modules or cells and collect fluid from multiple modules or cells into common return lines. The valves may comprise solenoid valves, proportional control valves, check valves, or other valve types configured to regulate fluid flow direction, flow rate, and pressure within the system. The pumps may comprise peristaltic pumps, diaphragm pumps, centrifugal pumps, or other pump types configured to circulate liquids through the system at controlled flow rates. The fluid circulation system establishes a return pathway through which liquid effluent containing carbon-containing species flows from the electrochemical fuel cell subsystem back to the shared electrolyte storage tank. The return pathway may include one or more intermediate processing stages, such as gas-liquid separators configured to separate entrained gas bubbles from the liquid effluent, or inline sensors configured to monitor effluent composition. The fluid circulation system enables continuous circulation of the aqueous electrolyte and the reduced carbon liquid fuel among the system components, supporting the closed-loop carbon conversion process.

The water recovery subsystem collects and recovers water generated as the byproduct of electrochemical conversion in the electrochemical fuel cell subsystem. Water may be produced at the cathode of the fuel cell subsystem during oxygen reduction and may also be present in the anode effluent stream. The water recovery subsystem may comprise one or more condensers configured to condense water vapor from gas streams exiting the fuel cell subsystem, one or more fluid separators configured to separate liquid water from electrolyte or fuel streams, or combinations thereof. The condensers may operate by cooling gas streams below their dew point using ambient air cooling, liquid coolant circulation, or thermoelectric cooling elements. The fluid separators may operate by gravity separation, membrane-based separation, or other liquid-liquid or gas-liquid separation techniques. Recovered water may be collected in a water storage vessel and made available as a useful output of the system. The water recovery subsystem may include sensors for monitoring water production rate, accumulated volume, and water quality parameters such as conductivity or pH. The relative rate of water recovery may be adjusted by modifying operating parameters of the fuel cell subsystem, such as current density, fuel flow rate, or oxygen supply rate, in coordination with the supervisory control system.

The supervisory control system coordinates operation of the electrochemical carbon dioxide reduction reactor, the electrochemical fuel cell subsystem, the fluid circulation system, and the water recovery subsystem. The supervisory control system comprises sensors distributed throughout the system and control logic configured to receive sensor data and generate control signals. The sensors may include voltage sensors, current sensors, temperature sensors, pressure sensors, flow rate sensors, level sensors, and chemical concentration sensors positioned at the electrochemical reactors, storage tanks, fluid conduits, and other system components. The control logic may be implemented using one or more programmable logic controllers, microcontrollers, embedded processors, or computing devices executing stored control software. The supervisory control system monitors system parameters including electrochemical cell voltages, current densities, fluid flow rates, tank levels, temperatures, and pressures, and uses these parameters to regulate pump speeds, valve positions, electrical loads, and reactor operating conditions. The supervisory control system enables selection among a plurality of operating modes. In an energy production mode, the supervisory control system configures system operation to prioritize net electrical energy production by adjusting the balance between the electrochemical carbon dioxide reduction reactor and the electrochemical fuel cell subsystem to maximize surplus electrical output. In a water production mode, the supervisory control system configures system operation to prioritize recovery of water as a useful output while maintaining energy balance. In an energy storage mode, the supervisory control system configures system operation to generate and store reduced carbon liquid fuel in the shared fuel storage tank for later energy production, which may be useful when external electrical energy is available to supplement internal generation. The supervisory control system may transition between operating modes based on external commands, scheduled profiles, or real-time sensor data. In certain embodiments, the supervisory control system employs adaptive algorithms or artificial intelligence-based methods to optimize system efficiency, predict maintenance requirements, adjust to changing component performance characteristics, and dynamically select among operating modes based on real-time operating conditions and external signals.

The system achieves self-sustaining operation following an initial startup phase. During the initial startup phase, stored electrical energy from an external source, such as a battery, a grid connection, or a renewable energy source, may supply the electrical energy required to initiate electrochemical reduction of carbon dioxide and to begin generating the reduced carbon liquid fuel. As the reduced carbon liquid fuel accumulates in the shared fuel storage tank and the electrochemical fuel cell subsystem begins converting the fuel into electrical energy, the system transitions toward a self-sustaining operating state. In the self-sustaining operating state, the electrical energy generated by the electrochemical fuel cell subsystem powers the electrochemical carbon dioxide reduction reactor, the pumps, the valves, the supervisory control system, and other internal system components, while simultaneously providing net surplus electrical energy for external use. The net surplus electrical energy may be delivered to external loads, exported to an electrical grid, stored in an external energy storage device, or used for other purposes. The self-sustaining operating state is maintained as long as the electrochemical fuel cell subsystem generates electrical energy in excess of the total internal energy consumption of the system, which includes the energy consumed by the electrochemical carbon dioxide reduction reactor and all balance-of-plant components. The energy balance may be managed by the supervisory control system through adjustment of reactor current densities, fuel cell operating points, and auxiliary component duty cycles.

The system operates as a closed-loop carbon conversion process. Carbon dioxide is electrochemically reduced to the reduced carbon liquid fuel in the electrochemical carbon dioxide reduction reactor. The reduced carbon liquid fuel is stored and subsequently consumed in the electrochemical fuel cell subsystem, where it is electrochemically oxidized to generate electrical energy and water, producing carbon dioxide as a reaction product. The carbon dioxide produced during fuel oxidation is carried in the liquid effluent through the return pathway to the shared electrolyte storage tank, where it dissolves in the aqueous electrolyte as dissolved carbon dioxide, bicarbonate, carbonate, or other carbon-containing species. The electrolyte containing these carbon-containing species is then delivered back to the electrochemical carbon dioxide reduction reactor for further reduction, completing the carbon cycle. During normal operation, carbon-containing species remain within the system and are not discharged to the atmosphere or otherwise removed. The system thereby treats carbon-containing species as regenerable energy carriers that cycle between reduced fuel states and oxidized carbon dioxide states, analogous to rechargeable chemical energy storage.

The system may be configured as a modular electrochemical system comprising a plurality of electrochemical modules housed within a common enclosure. Each electrochemical module comprises an electrochemical carbon dioxide reduction reactor and an electrochemical fuel cell subsystem. The plurality of electrochemical modules share the common shared electrolyte storage tank and the common shared fuel storage tank through the fluid circulation system. The manifolds of the fluid circulation system distribute electrolyte and fuel to each electrochemical module and collect effluent from each module for return to the shared storage tanks. This shared-resource architecture permits scalable deployment by addition or removal of electrochemical modules while maintaining the shared storage tanks and fluid circulation infrastructure. Adding electrochemical modules increases the system capacity for energy production, water recovery, or energy storage, while removing modules decreases capacity without requiring replacement of storage or infrastructure components. The supervisory control system may coordinate operation of the plurality of electrochemical modules independently, allowing individual modules to operate at different current densities, in different operating modes, or to be selectively activated or deactivated based on system demand or maintenance requirements.

The enclosure may comprise a transportable containerized structure, such as a standard intermodal shipping container or a purpose-built enclosure of similar dimensions, configured to house the electrochemical modules, shared storage tanks, fluid circulation system, water recovery subsystem, supervisory control system, and balance-of-plant components. The enclosure may include structural mounting points, vibration isolation elements, insulation, ventilation, and electrical connections configured to support transport by truck, rail, ship, or other conveyance, and to support installation at fixed or temporary deployment sites. Other enclosure types, including purpose-built buildings, skid-mounted frames, or open-air rack structures, may also be used.

Balance-of-plant components support the operation of the electrochemical subsystems and the fluid circulation system. Balance-of-plant components may include heat exchangers configured to transfer thermal energy between process streams or between process streams and an external cooling or heating medium, thereby managing operating temperatures within the electrochemical reactors and storage tanks. Balance-of-plant components may also include condensers for water recovery as described above, fluid separators for gas-liquid separation, power conditioning hardware such as DC-DC converters or DC-AC inverters for managing electrical output, and electrical distribution components for routing electrical energy among internal components and to external connections. The selection and configuration of balance-of-plant components may vary depending on the number of electrochemical modules, the intended operating modes, the deployment environment, and the desired output capacities for electrical energy and water.

Alternative embodiments may employ different methods, materials, and system configurations while achieving the same functional objectives. The electrochemical carbon dioxide reduction reactor and the electrochemical fuel cell subsystem may utilize alternative catalyst materials, including bio-derived catalysts, enzyme-based catalysts, or hybrid biological-electrochemical catalysts. Alternative membrane, separator, or electrolyte compositions may be used, including different ion-exchange membranes, polymer electrolytes, or biologically compatible media. The physical arrangement of tanks, reactors, and fluid pathways may vary, including different flow-field geometries, reactor orientations, or thermal management approaches. Operational alternatives may include continuous, semi-continuous, or batch-based operation, different duty-cycle strategies, and different configurations that adjust the balance among energy production, water production, and energy storage. These alternative methods, materials, and configurations are within the scope of the embodiments described herein, provided they implement the closed-loop carbon conversion, integrated energy generation, and water recovery functions described above.

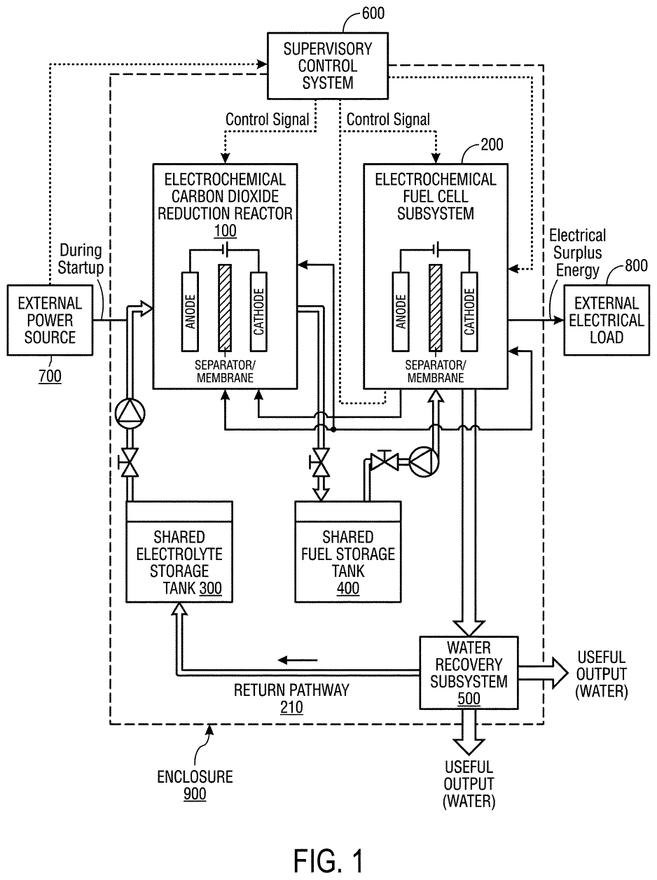

FIG. 1 illustrates a system-level block diagram of an integrated electrochemical system configured for closed-loop carbon conversion, energy generation, and water recovery. The system is housed within an enclosure 900, which may comprise a transportable containerized structure or other housing suitable for the deployment environment. Within the enclosure 900, the system includes an electrochemical carbon dioxide reduction reactor 100 and an electrochemical fuel cell subsystem 200. The electrochemical carbon dioxide reduction reactor 100 includes an anode and a cathode separated by a separator or membrane. The reactor 100 receives carbon dioxide and aqueous electrolyte and electrochemically converts the carbon dioxide into a reduced carbon liquid fuel at the cathode. The anode of the reactor 100 facilitates a complementary oxidation reaction, such as oxygen evolution from water, to complete the electrochemical circuit. The separator or membrane disposed between the anode and cathode permits selective ionic transport while preventing mixing of anode and cathode process streams.

The electrochemical fuel cell subsystem 200 also includes an anode and a cathode separated by a separator or membrane. The fuel cell subsystem 200 receives the reduced carbon liquid fuel and electrochemically oxidizes it at the anode to generate electrical energy, producing carbon dioxide and water as byproducts. The cathode of the fuel cell subsystem 200 reduces oxygen and combines it with protons or other ionic species transported through the separator or membrane to produce water. A portion of the electrical energy generated by the fuel cell subsystem 200 is delivered as electrical surplus energy 800 to an external electrical load for external use.

A shared electrolyte storage tank 300 stores aqueous electrolyte containing dissolved carbon species and is fluidly connected to both the electrochemical carbon dioxide reduction reactor 100 and the electrochemical fuel cell subsystem 200. The shared electrolyte storage tank 300 supplies aqueous electrolyte to the reactor 100 and receives liquid effluent containing carbon-containing species returned from the fuel cell subsystem 200 through a return pathway 210. The return pathway 210 carries liquid effluent containing dissolved or entrained carbon dioxide from the fuel cell subsystem 200 back to the shared electrolyte storage tank 300, enabling internal recirculation of carbon-containing species within the system without carbon discharge during normal operation.

A shared fuel storage tank 400 stores the reduced carbon liquid fuel generated by the electrochemical carbon dioxide reduction reactor 100. The shared fuel storage tank 400 is fluidly connected to the reactor 100, which delivers freshly produced reduced carbon liquid fuel to the tank 400, and to the fuel cell subsystem 200, which draws stored fuel from the tank 400 for electrochemical conversion.

A water recovery subsystem 500 receives water generated as a byproduct of the electrochemical conversion in the fuel cell subsystem 200. The water recovery subsystem 500 collects and recovers water as a useful output of the system. The recovered water exits the water recovery subsystem 500 as a useful output (water).

A supervisory control system 600 coordinates operation of the electrochemical carbon dioxide reduction reactor 100 and the electrochemical fuel cell subsystem 200. The supervisory control system 600 transmits control signals to the reactor 100 and the fuel cell subsystem 200 to regulate electrochemical operating parameters, fluid flow, and energy distribution. The supervisory control system 600 enables selection among a plurality of operating modes, including an energy production mode, a water production mode, and an energy storage mode.

An external power source 700 supplies electrical energy to the system during an initial startup phase. During startup, the external power source 700 provides the electrical energy required to initiate electrochemical reduction of carbon dioxide in the reactor 100 and to operate pumps, valves, and control hardware. Following the initial startup phase, the electrical energy generated by the fuel cell subsystem 200 becomes sufficient to power the reactor 100 and all internal system components while providing net surplus electrical energy 800 for external use, and the external power source 700 may be disconnected or placed in standby.

Fluid conduits, manifolds, and valves connect the shared electrolyte storage tank 300, the shared fuel storage tank 400, the electrochemical carbon dioxide reduction reactor 100, and the electrochemical fuel cell subsystem 200 to permit controlled circulation of liquids and gases within the system. These fluid circulation components are depicted as connecting lines between the system components in FIG. 1 and collectively form the fluid circulation system that supports the closed-loop carbon conversion process.

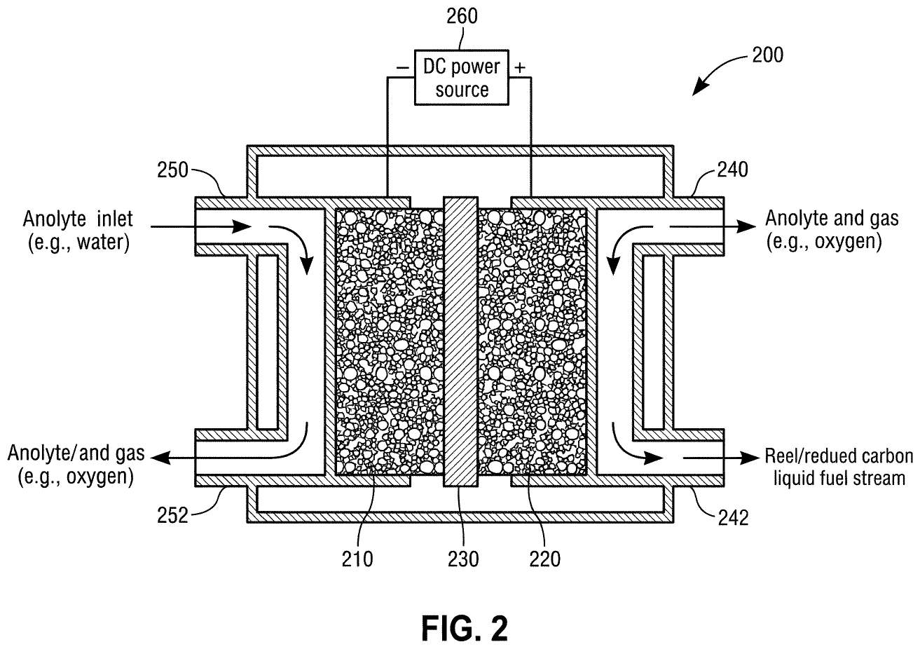

FIG. 2 illustrates a cross-sectional view of the electrochemical carbon dioxide reduction reactor, designated generally as 200 in this figure. The reactor comprises a housing that encloses the internal electrochemical cell components. A DC power source 260 is electrically connected to the reactor and supplies direct current electrical energy to drive the electrochemical reduction of carbon dioxide. The DC power source 260 connects its negative terminal to the cathode side and its positive terminal to the anode side of the electrochemical cell.

The reactor includes an anode 210 and a cathode 220 separated by a separator or membrane 230. The anode 210 receives an anolyte, such as water, through an anolyte inlet 250. The anolyte flows through the anode 210, where a complementary oxidation reaction occurs, such as oxygen evolution from water. The anolyte and evolved gas, such as oxygen, exit the anode side through an anolyte and gas outlet 240. On the opposite side of the separator or membrane 230, the cathode 220 receives aqueous electrolyte containing dissolved carbon dioxide or dissolved carbon species. The separator or membrane 230 permits selective ionic transport between the anode 210 and the cathode 220 while preventing bulk mixing of the anolyte and catholyte streams. The cathode 220 comprises catalyst materials, which may include non-precious and non-rare materials, disposed on or within a porous conductive substrate. The porous structure of the cathode 220, depicted as a textured region in FIG. 2, provides a high surface area for electrochemical reactions and permits fluid flow through the electrode structure.

When the DC power source 260 applies electrical energy across the anode 210 and cathode 220, carbon dioxide dissolved in the catholyte is electrochemically reduced at the cathode 220 surface to produce a reduced carbon liquid fuel, such as formate. The reduced carbon liquid fuel exits the cathode side of the reactor as a reduced carbon liquid fuel stream through outlet 242. This reduced carbon liquid fuel stream is delivered to the shared fuel storage tank for storage and subsequent use by the electrochemical fuel cell subsystem. An additional anolyte and gas outlet 252 may be provided on the anode side to accommodate gas and liquid separation.

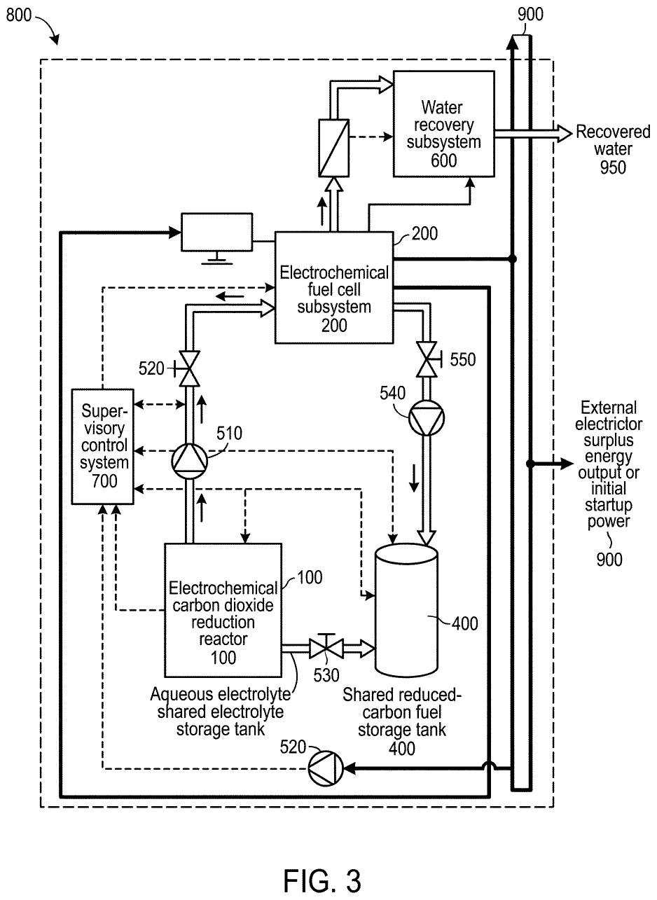

FIG. 3 illustrates a detailed system schematic of a single-module embodiment of the integrated electrochemical system, with the system housed within an enclosure 800. The enclosure 800 may comprise a transportable containerized structure and contains the electrochemical subsystems, shared storage tanks, fluid circulation components, the water recovery subsystem, and the supervisory control system.

Within the enclosure 800, an electrochemical carbon dioxide reduction reactor 100 receives aqueous electrolyte containing dissolved carbon species from a shared electrolyte storage tank, depicted at the lower left of the schematic. The shared electrolyte storage tank stores the aqueous electrolyte and is fluidly connected to the reactor 100 through fluid conduits and a pump 520. The pump 520 circulates the aqueous electrolyte from the shared electrolyte storage tank to the reactor 100 at a controlled flow rate. The reactor 100 electrochemically converts the carbon dioxide dissolved in the aqueous electrolyte into a reduced carbon liquid fuel.

The reduced carbon liquid fuel produced by the reactor 100 is delivered through a fluid conduit and a valve 530 to a shared reduced-carbon fuel storage tank 400. The shared reduced-carbon fuel storage tank 400 stores the reduced carbon liquid fuel and is depicted at the lower right of the schematic. A pump 520 circulates the reduced carbon liquid fuel from the shared reduced-carbon fuel storage tank 400 through fluid conduits to an electrochemical fuel cell subsystem 200. The electrochemical fuel cell subsystem 200 receives the reduced carbon liquid fuel and electrochemically converts it into electrical energy, generating water and carbon dioxide as byproducts.

The fuel cell subsystem 200 produces a liquid effluent stream containing electrolyte and dissolved or entrained carbon dioxide. This liquid effluent stream exits the fuel cell subsystem 200 and flows through fluid conduits back to the shared electrolyte storage tank, establishing the return pathway for internal carbon recirculation. A valve 550 may be positioned along this return pathway to regulate the flow of liquid effluent. The carbon-containing species in the returned liquid effluent are thereby made available in the shared electrolyte storage tank for subsequent delivery to the reactor 100, completing the closed-loop carbon conversion cycle.

A water recovery subsystem 600 receives water generated as a byproduct from the fuel cell subsystem 200. The water recovery subsystem 600 collects, condenses, and separates water from the fuel cell process streams. Recovered water 950 exits the water recovery subsystem 600 as a useful output of the system.

A supervisory control system 700 is communicatively connected to the reactor 100, the fuel cell subsystem 200, the pumps 520, and the valves 530 and 550 through control signal lines depicted as dashed lines in FIG. 3. The supervisory control system 700 monitors system parameters through sensors distributed throughout the system and generates control signals to regulate pump speeds, valve positions, reactor current densities, and fuel cell operating points. The supervisory control system 700 enables selection among a plurality of operating modes and may employ adaptive algorithms or artificial intelligence-based methods to optimize system operation.

A conduit 510 connects the fuel cell subsystem 200 to the power distribution infrastructure within the enclosure 800. An external connection 900 provides for the delivery of net surplus electrical energy to an external load or grid during self-sustaining operation, and also provides for the receipt of initial startup power from an external energy source during the initial startup phase. A valve 540 may be positioned within the fluid circulation system to support additional flow control between the fuel cell subsystem 200 and the water recovery subsystem 600.

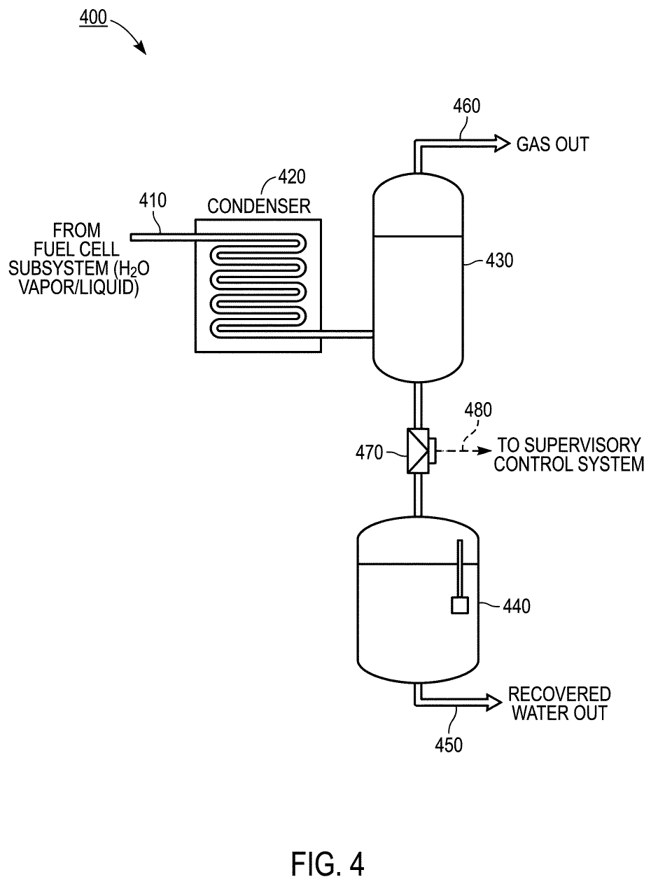

FIG. 4 illustrates a detailed schematic of the water recovery subsystem, designated generally as 400 in this figure. The water recovery subsystem receives an input stream 410 from the fuel cell subsystem. The input stream 410 comprises water in vapor and liquid phases (H₂O vapor/liquid) carried in the effluent of the fuel cell subsystem.

The input stream 410 enters a condenser 420. The condenser 420 cools the input stream to condense water vapor into liquid water. The condenser 420 may operate by circulating a cooling medium through coiled or finned tubing, depicted as a serpentine coil in FIG. 4, through which the input stream passes. As the input stream cools below its dew point, water vapor condenses into liquid water, which collects and drains downward by gravity.

The condensed liquid water and any remaining gas exit the condenser 420 and enter a gas-liquid separator vessel 430. The gas-liquid separator vessel 430 separates residual gas from the condensed liquid water. Gas that does not condense, which may include residual carbon dioxide or other non-condensable gases, rises to the top of the separator vessel 430 and exits through a gas outlet 460. The gas outlet 460 may direct the separated gas to the shared electrolyte storage tank for dissolution and carbon recirculation, or may vent the gas through a controlled release depending on system configuration and operating mode.

The condensed liquid water collects in the lower portion of the gas-liquid separator vessel 430 and drains into a water storage vessel 440. The water storage vessel 440 accumulates recovered water for delivery as a useful output. A flow sensor 470 monitors the flow rate of recovered water exiting the water storage vessel 440. The flow sensor 470 communicates with the supervisory control system through a signal connection 480 depicted as a line leading to the supervisory control system. The supervisory control system uses data from the flow sensor 470 to monitor water production rates, adjust operating parameters of the fuel cell subsystem to modulate water generation, and select operating modes that prioritize water production or energy production. A water quality sensor, such as a conductivity or pH sensor, may also be positioned at the water storage vessel 440 to monitor the quality of recovered water.

Recovered water exits the water storage vessel 440 through a recovered water outlet 450. The recovered water outlet 450 delivers the recovered water as a useful output of the system for collection, storage, or external use.

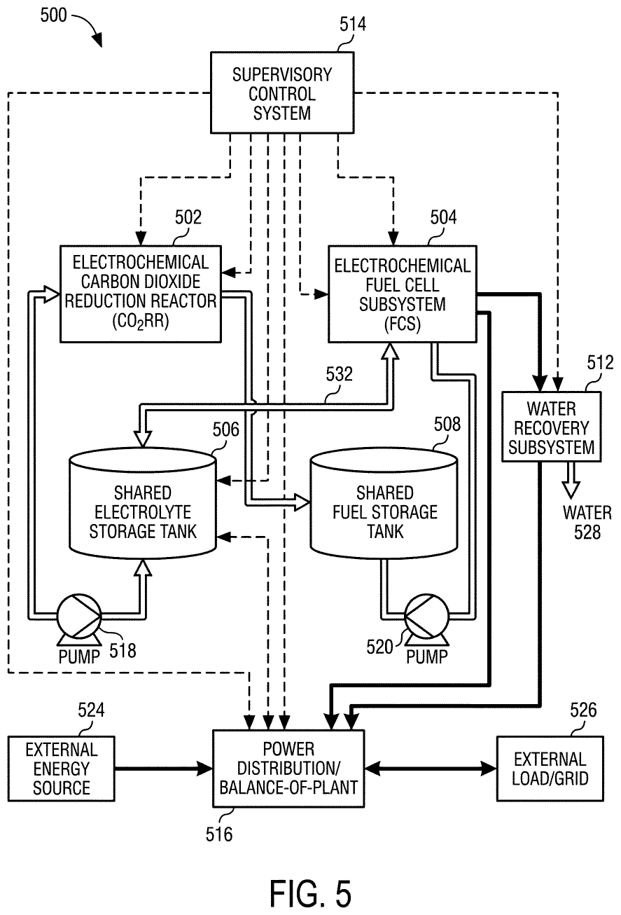

FIG. 5 illustrates a system-level block diagram of a modular electrochemical system, designated generally as 500. The modular electrochemical system 500 comprises a plurality of electrochemical modules housed within a common system boundary. In the embodiment depicted in FIG. 5, the system includes at least two electrochemical modules. A first electrochemical module comprises an electrochemical carbon dioxide reduction reactor (CO₂RR) 502 and an electrochemical fuel cell subsystem (FCS) 504 operating as a paired unit. Additional electrochemical modules, each comprising a paired CO₂RR and FCS, may be included within the system, as indicated by the parallel arrangement of the depicted modules.

Each electrochemical carbon dioxide reduction reactor 502 receives aqueous electrolyte containing dissolved carbon species from a shared electrolyte storage tank 506. Each reactor 502 electrochemically converts carbon dioxide into a reduced carbon liquid fuel, which is delivered to a shared fuel storage tank 508 through fluid conduits. Each electrochemical fuel cell subsystem 504 receives the reduced carbon liquid fuel from the shared fuel storage tank 508 and electrochemically converts it into electrical energy, generating water and carbon dioxide as byproducts. Liquid effluent containing carbon-containing species is returned from each fuel cell subsystem 504 to the shared electrolyte storage tank 506 through a return pathway depicted as a fluid conduit 532, enabling internal carbon recirculation across the plurality of electrochemical modules.

The shared electrolyte storage tank 506 serves as a common reservoir for the aqueous electrolyte used by all electrochemical modules. A pump 518 circulates aqueous electrolyte from the shared electrolyte storage tank 506 to the plurality of electrochemical carbon dioxide reduction reactors 502 through fluid conduits and manifolds. The shared fuel storage tank 508 serves as a common reservoir for the reduced carbon liquid fuel generated by all reactors 502 and consumed by all fuel cell subsystems 504. A pump 520 circulates the reduced carbon liquid fuel from the shared fuel storage tank 508 to the plurality of fuel cell subsystems 504. The shared storage architecture permits scalable deployment by addition or removal of electrochemical modules while maintaining the shared electrolyte storage tank 506 and the shared fuel storage tank 508.

A water recovery subsystem 512 receives water generated as a byproduct from the electrochemical fuel cell subsystems 504 of the plurality of electrochemical modules. The water recovery subsystem 512 collects and recovers water 528 as a useful output of the system.

A supervisory control system 514 is communicatively connected to each electrochemical carbon dioxide reduction reactor 502, each electrochemical fuel cell subsystem 504, the pumps 518 and 520, and other system components through control signal lines depicted as dashed lines in FIG. 5. The supervisory control system 514 coordinates operation of the plurality of electrochemical modules, monitors system parameters, and generates control signals to regulate electrochemical operating conditions, fluid flow rates, and energy distribution. The supervisory control system 514 enables selection among a plurality of operating modes and may operate individual electrochemical modules at different current densities, in different modes, or may selectively activate or deactivate individual modules based on system demand, maintenance requirements, or real-time operating conditions.

A power distribution and balance-of-plant block 516 manages electrical energy flows within the modular electrochemical system 500. The power distribution and balance-of-plant block 516 receives electrical energy generated by the fuel cell subsystems 504 and distributes it to the electrochemical carbon dioxide reduction reactors 502, the pumps 518 and 520, the supervisory control system 514, and other internal components. The power distribution and balance-of-plant block 516 may include DC-DC converters, DC-AC inverters, electrical switchgear, and thermal management components such as heat exchangers. An external energy source 524 may supply electrical energy to the power distribution and balance-of-plant block 516 during the initial startup phase. Following the initial startup phase, net surplus electrical energy generated by the system is delivered through the power distribution and balance-of-plant block 516 to an external load or grid connection 526 for external use.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. An integrated electrochemical system comprising:
an electrochemical carbon dioxide reduction reactor configured to receive carbon dioxide and an aqueous electrolyte and to electrochemically convert the carbon dioxide into a reduced carbon liquid fuel;
an electrochemical fuel cell subsystem configured to receive the reduced carbon liquid fuel and to electrochemically convert the reduced carbon liquid fuel into electrical energy, wherein water is generated as a byproduct of the electrochemical conversion;
a shared electrolyte storage tank fluidly connected to the electrochemical carbon dioxide reduction reactor and the electrochemical fuel cell subsystem, the shared electrolyte storage tank configured to store the aqueous electrolyte containing dissolved carbon species;
a shared fuel storage tank fluidly connected to the electrochemical carbon dioxide reduction reactor and the electrochemical fuel cell subsystem, the shared fuel storage tank configured to store the reduced carbon liquid fuel generated by the electrochemical carbon dioxide reduction reactor;
a fluid circulation system comprising conduits, manifolds, and valves connecting the shared electrolyte storage tank, the shared fuel storage tank, the electrochemical carbon dioxide reduction reactor, and the electrochemical fuel cell subsystem to permit controlled circulation of liquids and gases within the system; and
a return pathway configured to return carbon-containing species from the electrochemical fuel cell subsystem to the shared electrolyte storage tank,
wherein the system is configured for closed-loop carbon conversion in which carbon-containing species are cycled between reduced and oxidized states within the system without carbon discharge during normal operation, and
wherein, following an initial startup phase, the electrical energy generated by the electrochemical fuel cell subsystem is sufficient to power the electrochemical carbon dioxide reduction reactor and internal system components while providing net surplus electrical energy for external use.

2. The system of claim 1, further comprising a water recovery subsystem configured to collect and recover water generated as the byproduct of the electrochemical conversion in the electrochemical fuel cell subsystem, wherein the recovered water is treated as a useful output of the system.

3. The system of claim 1, wherein the system is configured to operate in a plurality of operating modes using a common physical architecture, the plurality of operating modes comprising at least two of:
an energy production mode in which operation is configured to prioritize net electrical energy production;
a water production mode in which operation is configured to prioritize recovery of water as a useful output; and
an energy storage mode in which the reduced carbon liquid fuel is generated and stored in the shared fuel storage tank for later energy production.

4. The system of claim 1, further comprising a supervisory control system comprising sensors and control logic configured to monitor system parameters and to coordinate operation of the electrochemical carbon dioxide reduction reactor, the electrochemical fuel cell subsystem, and the fluid circulation system to enable selection among a plurality of operating modes.

5. The system of claim 4, wherein the supervisory control system employs at least one of adaptive algorithms or artificial intelligence-based methods to optimize efficiency, manage maintenance, extend component life, or dynamically select among the plurality of operating modes based on real-time operating conditions.

6. The system of claim 1, wherein the electrochemical carbon dioxide reduction reactor and the electrochemical fuel cell subsystem comprise non-precious and non-rare catalyst materials.

7. The system of claim 1, wherein the reduced carbon liquid fuel comprises formate.

8. The system of claim 1, further comprising balance-of-plant components including at least one of pumps, heat exchangers, condensers, or fluid separators configured to support fluid circulation, thermal management, or water recovery within the system.

9. A modular electrochemical system housed within an enclosure, the system comprising:
a shared electrolyte storage tank configured to store an aqueous electrolyte containing dissolved carbon species;
a shared reduced-carbon fuel storage tank configured to store a reduced carbon liquid fuel;
a plurality of electrochemical modules, each electrochemical module comprising:
an electrochemical carbon dioxide reduction reactor configured to receive carbon dioxide and the aqueous electrolyte from the shared electrolyte storage tank and to electrochemically convert the carbon dioxide into the reduced carbon liquid fuel for delivery to the shared reduced-carbon fuel storage tank; and
an electrochemical fuel cell subsystem configured to receive the reduced carbon liquid fuel from the shared reduced-carbon fuel storage tank and to electrochemically convert the reduced carbon liquid fuel into electrical energy, wherein water is generated as a byproduct;
a fluid circulation system connecting each electrochemical module to the shared electrolyte storage tank and the shared reduced-carbon fuel storage tank; and
a carbon recirculation pathway configured to return liquid effluent containing carbon-containing species from each electrochemical fuel cell subsystem to the shared electrolyte storage tank,
wherein the system is configured such that carbon-containing species are internally recirculated and are not discharged during normal operation, and
wherein the modular electrochemical system is scalable by addition or removal of electrochemical modules while maintaining the shared electrolyte storage tank and the shared reduced-carbon fuel storage tank.

10. The modular electrochemical system of claim 9, wherein the enclosure comprises a transportable containerized structure.

11. The modular electrochemical system of claim 9, wherein, following an initial startup phase, electrical energy generated by the plurality of electrochemical modules is sufficient to power all internal system components including the electrochemical carbon dioxide reduction reactors, pumps, and control hardware, while providing net surplus electrical energy for external use.

12. The modular electrochemical system of claim 9, further comprising a water recovery subsystem configured to collect water generated as the byproduct from the electrochemical fuel cell subsystems of the plurality of electrochemical modules, wherein the water is recovered as a useful output of the system.

13. The modular electrochemical system of claim 9, further comprising a supervisory control system configured to coordinate operation of the plurality of electrochemical modules and to dynamically select among a plurality of operating modes, the plurality of operating modes comprising at least one of an energy production mode, a water production mode, or an energy storage mode.

14. The modular electrochemical system of claim 9, wherein the electrochemical carbon dioxide reduction reactors and the electrochemical fuel cell subsystems of the plurality of electrochemical modules comprise non-precious and non-rare catalyst materials.

15. A method for generating electrical energy and recovering water using a closed-loop carbon conversion process, the method comprising:
electrochemically reducing carbon dioxide in an electrochemical carbon dioxide reduction reactor in the presence of an aqueous electrolyte to produce a reduced carbon liquid fuel;
storing the reduced carbon liquid fuel in a shared fuel storage tank;
electrochemically converting the reduced carbon liquid fuel in an electrochemical fuel cell subsystem to generate electrical energy and water as a byproduct;
returning carbon-containing species generated during the electrochemical converting step from the electrochemical fuel cell subsystem to a shared electrolyte storage tank fluidly connected to the electrochemical carbon dioxide reduction reactor, thereby enabling internal recirculation of carbon-containing species without carbon discharge during normal operation;
recovering the water generated during the electrochemical converting step as a useful output; and
following an initial startup phase, sustaining operation of the electrochemical carbon dioxide reduction reactor and internal system components using the electrical energy generated by the electrochemical fuel cell subsystem while providing net surplus electrical energy for external use.

16. The method of claim 15, further comprising regenerating the reduced carbon liquid fuel by electrochemically reducing the carbon-containing species returned to the shared electrolyte storage tank, thereby enabling repeated use of a carbon inventory without continuous external fuel supply.

17. The method of claim 15, further comprising selecting an operating mode from a plurality of operating modes using a supervisory control system, the plurality of operating modes comprising at least two of:
an energy production mode prioritizing net electrical energy production;
a water production mode prioritizing recovery of water; and
an energy storage mode in which the reduced carbon liquid fuel is generated and stored for later energy production.

18. The method of claim 15, wherein the reduced carbon liquid fuel comprises formate.

19. The method of claim 15, wherein the electrochemically reducing step and the electrochemically converting step are performed using non-precious and non-rare catalyst materials.

20. The method of claim 15, further comprising scaling the method by deploying a plurality of electrochemical modules within a common enclosure, each electrochemical module comprising an electrochemical carbon dioxide reduction reactor and an electrochemical fuel cell subsystem connected to the shared electrolyte storage tank and the shared fuel storage tank.
